(19) United States
(12) Patent Application Publication
(10) Pub. No.: US 2008/0209759 A1
(43) Pub. Date: Sep. 4, 2008

(54) Counter flow air cooling drier with fluid heating and integrated heat recovery

(76) Inventor: Steve D. Shivvers, Prole, IA (US)

Correspondence Address: LAW OFFICE OF JOHN C. MCMAHON, P.O. BOX 30069, KANSAS CITY, MO, 64112, US

(21) Appl. No.: 12/011,323

(22) Filed: Jan. 25, 2008

Related U.S. Application Data
(60) Provisional application No. 60/897,597, filed on Jan. 26, 2007.

(51) Int. Cl. F26B 3/18; F28C 3/08

(52) U.S. Cl. 34/514; 34/68; 34/78

(57) ABSTRACT

A drier apparatus for removing water from various materials includes a drying chamber, a regenerator system, a drying fluid system, and a heating fluid recirculation system and a method for use of the apparatus. The material to be dried flows concurrently through the drier with a heating fluid that is segregated from the material but in heat transfer relationship with the material. A drying fluid flows countercurrent through the chamber so as to become heated and at least partially saturated from moisture released by the material. The drying fluid is then used to preheat recycled heating fluid which is further heated by a makeup heater. In some embodiments, the drying fluid is also recycled to the chamber after passing through a chiller.

### CROSS REFERENCE TO RELATED APPLICATIONS

This application claims the benefit of U.S. Provisional Application No. 60/897,597, filed Jan. 26, 2007 which is incorporated herein by reference.

### STATEMENT REGARDING UNITED STATES GOVERNMENT SPONSORED RESEARCH OR DEVELOPMENT

The present invention was at least in part made with support from the United States Government under Contract No. 2005-33610-15517 awarded by the USDA SBIR. The United States Government has certain rights in the invention.

### BACKGROUND OF THE INVENTION

The present invention is directed to improvements in driers and methods of removing volatile compounds from materials by the application of heat and where such heat is reclaimed and recycled in the method.

The drying industry is very large and utilizes significant amounts of both fossil fuels and electricity to dry various materials. While the grain industry is not the only industry that requires significant drying, it is indicative of the problems that exist. Just the U.S. corn crop amounts to over nine billion bushels annually. At least part of the moisture present at harvest must be removed in order to allow the grain to be stored without significant loss due to mold, mildew and rot, all of which are caused by excess retained moisture.

In theory, each pound of water removed from the grain has a latent heat of vaporization of about 1160 British thermal units (Btu's) per pound. In a highly effective drier system, the drier could import exactly this theoretical amount of energy for per pound of water to be removed from the material to be dried. In reality, the material to be dried also takes on sensible heat and rises in temperature, the flow of heating media is not uniform, the material is often heated more on one side of the drier than the other, etc., such that the efficiency of all type of conventional driers is comparatively low. For example, conventional cross flow grain driers usually require more than 2000 Btu per pound of water removed versus the theoretical amount of 1160 Btu per pound.

Because just the corn industry in the U.S. consumes approximately 900 million gallons of propane and over 3200 million kilowatt-hours of electricity per year just to dry the corn and because this produces nearly two million tons of carbon dioxide exhaust gases per year due to the burning of fossil fuels, it is seen that any improvement in drying efficiency can amount to significant savings in fuel, energy and emissions. Corn is only one type of grain that must be dried. Further, there are many other solids, semi-solids and initially liquid compositions that are dried each year at considerable cost in terms of fuel, energy and undesired emissions due to combustion of the fuels.

It is further noted that for some materials the manner of drying is important to prevent excessive shock to the product being dried and/or to reduce inconsistency in the dried material. For example, grain kernels can be cracked by cooling or heating too quickly, which can lead to degradation of the grain. While conventional driers may produce a chosen average moisture content, the content may not be consistent throughout the grain. Consequently, problems are encountered in many types of conventional grain cross flow driers, where the grain is heated and dried by air passing perpendicularly to the flow of the grain. In such driers, the grain on one side of the drier that first encounters the heated air is overly dried and may be dried too quickly or cooled too quickly so as to cause cracking and the grain on the opposite or on air discharge side tends to be too wet. Therefore, it is also desirable to provide a drier that provides consistent, uniform and non stressful heating to drive off moisture and thereafter provide uniform and non stressful cooling within the drying process.

In some circumstances, it is also desirable to provide a closed recycle system for gas used in the drying process to reduce dust or other undesirable emissions.

### SUMMARY OF THE INVENTION

A drier wherein a granular, pelletized, semi fluid or other material having moisture therein that is to be removed by drying is allowed to flow through a drying chamber from a first end or entrance to a second end or exit thereof. A heating fluid at a temperature greater than the initial temperature of the material to be dried and which can be gaseous or liquid is also conveyed separately from the material to be dried through the chamber from near the entrance to near the exit in generally concurrent flow with the material to be dried.

Preferably, the heating fluid is maintained in piping or tubing that flows along the side of or within the chamber, so as to transfer heat from the fluid to the material to be dried. While a portion of this heat may be utilized as sensible heat to raise the temperature of the material to be dried, a substantial portion of the heat will become latent heat of vaporization to change the phase of moisture within the material from a liquid state to a vapor state. The change of phase proceeds much the same as in the wet-bulb of a psychrometer and can depress the temperature of the material to be dried. The temperature depression enhances the heat transfer from the heating fluid to the material to be dried. Still more preferably the heating fluid flows in a helically or spirally wound path along and adjacent the camber.

A drying fluid, normally and preferably air that is ambient or recycled, especially if exhaust emissions are of a concern, is counterflowed through the material from near the chamber second end to preferably near the chamber first end. For certain materials, a fluid other than air may be required, especially if there is an explosive risk. At the introduction of the drying fluid into the chamber at the second end, the temperature of the drying fluid is less than the temperature of the heating fluid at the second end of the chamber such that the drying fluid rises in temperature as it flows countercurrent to the heating fluid through the chamber. This rise in temperature causes a rise in the saturated vapor pressure or moisture holding capacity of the drying fluid allowing the drying fluid to hold greater and greater amounts of moisture as the drying fluid flows through the chamber. In particular, sensible heat transfers from the heating fluid to the material to be dried where a large part of said heat is transformed into the latent heat of vaporization to prepare the moisture to be carried away by the drying fluid. During passage through the chamber the drying fluid absorbs the moisture released from the material to be dried, so as to become more saturated when the drying fluid exits the first end or drying fluid exit of the chamber. In this manner, the drying fluid dries the material while also cooling the material across a temperature gradient of cool to hot from near the material exit to near the material entrance.

At the chamber material exit, the material, at that location cool and comparatively drier is removed from the chamber. In some instances the material may be completely dry and in others instances partially dried, for example a percentage of the water such as “four points” or four percent by weight may be removed with a single pass through the drier and multiple passes may be required.

The exiting material, which is at that point comparatively drier than the original wet material, is then transferred to storage or the like. The heating fluid which has been cooled by passage through the chamber, is flowed back to the entrance after reheating so as to heat the material to be dried coming into the chamber. Subsequent to exiting the chamber, the drying fluid which has been heated by passage through the chamber and at least partially saturated with moisture is counter flowed in a heat exchanger relative to the heating fluid that has been recovered from the exit of the chamber, so that the heating fluid is at least partially reheated by the drying fluid after the drying fluid exits the chamber. This allows the recovery of both sensible and latent heat from the drying fluid by the heating fluid. Note that the terms heating and cooling or hot and cool have to do with the comparative states of the fluids when the fluids first enter the chamber and that they reverse so as to be cooler or hotter respectively than each other during various stages of the process.

Because the recycled heating fluid is relatively cool after exiting the chamber and the drying fluid exiting the chamber is comparatively hot and at least partly saturated with moisture, as the drying fluid cools during the heating of the heating fluid, moisture condensate forms on the drying fluid side of the heat exchanger and is collected and withdrawn. Prior to entering the chamber to heat the incoming material to be dried, the partly heated heating fluid passes through a makeup or supplemental heater that further heats the media to a preselected temperature that is determined to be best for initial thermal contact with the incoming material to be dried. Makeup heat can be alternatively transferred directly to the wet incoming material or at other locations in the recirculation system for the heating fluid.

In certain embodiments, the drying fluid after preheating the heating fluid is collected and returned to the drying chamber for recycle or repassing through the material therein. Because the drying fluid that is recycled in this manner may in some cases become somewhat hotter than the drying fluid at the beginning of the process initially (for example, ambient air), an intermediate chiller, heat pump, or the like may be utilized to cool the drying fluid to a preselected temperature before flowing into the material in the chamber. In this manner, the drying fluid is not exhausted to the atmosphere, so as to reduce dust or other undesirable emissions that may be contained within the drying fluid or for other reasons.

The heating fluid may be any suitable material that can function to become heated and convey such heat to the material to be dried. Such heating fluid could be water, air, oil or other types of fluids that are used for transfer of heat. Preferably, the heating fluid is stable and not significantly damaged by recycle usage. The chamber may be any suitable device for allowing counterflow movement of the material and drying fluid therein. Suitable chambers include rotary drums that are segmented or unsegmented and which have a varying length to diameter ratio. Chambers could also include vertical columns and other structures about or within which the heating fluid can be conveyed by appropriate plenums or piping, generally concurrent to the flow of the material. Such structures include fluidized beds, tunnel, belt, conveyor, rotary drum, disc and auger, tray and the like structures.

Therefore, the basic process of the invention in general is concurrently flowing a material to be dried with a segregated or separating heating fluid that is preheated with recovered or reclaimed sensible and/or latent heat in a first direction through a chamber. An initially comparatively cool drying fluid is generally counter flowed in the opposite direction through the material in the chamber such that the material is initially heated by the heating fluid so as to evaporate water therein and then cooled while being dried by the drying fluid which becomes more saturated with moisture from the material. The heated and moisture carrying drying fluid is then generally counter flowed in heat transfer relationship with the heating fluid that has exited the second end of the chamber and condensate is removed, so that the heating fluid is at least partly reheated or preheated. Preferably, at least partly heated heating fluid is then further heated by a makeup heater and returned to the chamber to heat the incoming material to be dried, although makeup heat to get the material to a preselected temperature when entering the chamber can also be applied in other ways such as directly to the incoming material. The process, therefore, heats the material to be dried and dries the material by flowing drying fluid therethrough. The incoming comparatively cool and dry drying fluid becomes heated and removes moisture vaporized or evaporated from the material to be dried as the drying fluid passes through the chamber. Much of the sensible and latent heat utilized to drive moisture from the material is recovered and reused in this manner, thereby requiring comparatively little supplemental or makeup heat input into the heating fluid other than being heated by the hot drying fluid.

While principally counter current flow processes are described above and preferred, both with respect to the drying of the material and the reheating of the heating fluid relative to the flow of the drying fluid, it is foreseen that some processes may be at least partially counter flow, cross-flow, concurrent flow or mixtures thereof. The material to be dried can be passed stepwise through various combinations of counterflow, concurrent flow, cross-flow or the like sections, preferably with overall flow being generally countercurrent. As used herein stepwise means following a sequential path through such various sections which can be open regions, generally closed regions or combinations thereof. The process could also be conducted in sequential passes through the drier wherein a certain amount of moisture is removed in each pass and the material to be dried can be recycled to remove a percentage of moisture with each pass through the drier.

It is also noted that while principally concurrent flow processes are described above and preferred, with respect to the flow of material being dried relative to the flow of the heating fluid, it is foreseen that this process may be partially counter flow, cross-flow, concurrent flow, or mixtures thereof and may be conducted in sequential steps or stepwise provided that the general overall flow from entry to exit within the drying chamber is generally concurrent, such that material being processed (normally at ambient) enters the drying chamber generally concurrent with hot heating fluid and the heating fluid exits the drying chamber cooler than it entered.

### OBJECTS AND ADVANTAGES OF THE INVENTION

Therefore, the objects of the invention are: to provide a drier that is especially effective in drying material with less outside energy input as compared to conventional driers; to provide such a drier that is effective in uniformly and consistently drying materials, especially granular materials such as grain, wood pellets or the like; to provide such a drier that heats material to be dried by generally overall concurrent flow in a heat transfer relationship with a segregated heating fluid and passing the material while being heated through a drying chamber in general overall counter flow relation to a drying fluid, such as air, that is in direct contact with the material and wherein the drying fluid is initially comparatively cool and is heated and gradually becomes more saturated with moisture as the drying fluid passes through the material; to provide such a drier wherein the heating fluid upon exiting the drier, when comparatively cool, is overall generally counter flowed relative to the drying fluid in a heat transfer relationship in a heat exchanger and, thereafter, the heating fluid is heated by a supplemental heater to a preselected temperature prior to being returned to the chamber or heat is otherwise added to the system; to provide such a drier that can be converted to allow enclosed recycle of the drying fluid to reduce undesirable emissions; to provide such a drier that has a comparatively high efficiency wherein comparatively little heat is required from an external heating source, in comparison to conventional driers; and to provide such a drier that is easy to use, economical to build and operate and especially well adapted for the intended purpose thereof.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a partially schematic view of a drier in accordance with the present invention having a sloped and rotatable segmented drying chamber.

FIG. 1A is a drier similar to that of FIG. 1 having a fluid recycle system and a fluid chiller.

FIG. 2 is a partially schematic view of a first modified drier in accordance with the present invention having a slopped unsegmented drying chamber with a comparatively high length to diameter ratio.

FIG. 2A is a drier similar to the drier of FIG. 2 having a fluid recycle system and a fluid chiller.

FIG. 3 is a schematic diagram of a further alternative flow process wherein a first flow component flows generally overall counterflow to a second flow component, but in discrete stages flows partially concurrently with the second component.

FIG. 4 is a schematic diagram of a still further alternative flow process wherein a first flow component flows generally overall counterflow to a second flow component, but in stages partially flows cross flow relative to the second component.

FIG. 5 is a schematic diagram of a yet further alternative flow process wherein a first component flows generally overall counterflow to a second flow component, but in stages partially flows in mixed flow relative to the second component.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

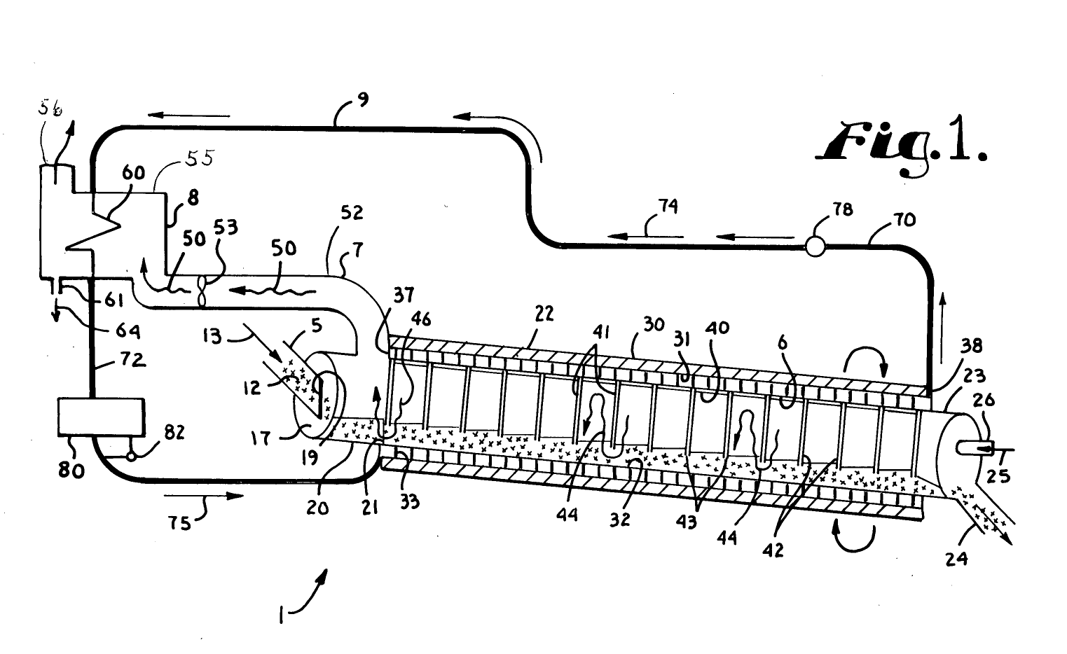

As shown in FIG. 1, the reference numeral 1 generally represents a drier in accordance with the present invention. The drier 1 comprises an inlet chute 5, a drying chamber 6, a drying fluid system 7, a regenerator system 8 and a heating flow apparatus or fluid circulation system 9.

A material 12 to be dried (here particulate material such as corn) is fed at the arrow numbered 13 into the chute 5 from a source (not shown) outside the drier 1. The material 12 enters a first end 17 of the chamber 6. An airlock 19 is located where the material 12 enters the chamber 6. The chamber 6 can be many different shapes, but at least in some embodiments is round to allow rotation for tumbling of the material and for structural strength.

The chamber 6 includes a stationary front region 20 that is rotatably joined at a joint 21 to a middle section 22. The middle section 22 is cylindrical in shape and substantially longer in length than in width.

Opposite the front portion 20 is a rear portion 23 also fixed in position and rotatably joined to the middle portion 22. The material 12 passes through the chamber 6 and exits the chamber 6 into the rear portion 23 relatively cool and comparatively drier than when the material 12 entered the chamber 6. A discharge chute 24 conveys the exiting material 12 from the chamber 6.

When drying most materials that absorb liquids, it is preferable that the drying fluid be a gaseous fluid, typically air, but other types of fluids are also effective, especially nitrogen where there is a high explosive risk. Drying fluid (here air indicated by the arrow 25) enters the chamber 6 through an inlet tube 26.

The chamber middle section 22 has an outer shell 30 constructed of a strong and durable material such as steel and including an inner insulation layer 31. It is foreseen that the insulation layer could also be on the outside of the shell. Joined to the shell 30 and located radially inward of the insulation layer 31 is a heating coil 32. The heating coil comprises a helically or spirally wound length of tubing 33 or similar structure that extends between first and second ends 37 and 38 of the middle portion 22.

Located in the middle portion 22 is an inner support 40 that is suspended between the front portion 20 and rear portion 23 so as to be stationary and not rotate with the shell 30 of the middle portion 22. Depending from the support 40 are a plurality of radially extending plates 42 which seal about the sides and top of the middle portion 22 so as to segment the middle portion 22 into a plurality of side by side regions 41, but which are spaced from the bottom sufficiently so as to allow flow of material 12 to be dried under plate bottoms 43. The drying fluid, as represented by the arrows 44, also flows under the plates 42 and through the chamber 6 in the opposite direction or counterflow to the material 12.

The warm drying fluid near the front 20 of the chamber 6, as indicated by the arrow 46, exits the middle portion 22 and enters the front portion 20. The drying fluid as represented by the arrows 50 then passes through a collection conduit 52 through which the drying fluid is driven by a fan 53. The fan 53 effectively draws the drying fluid through the chamber 6 into the drying fluid system 7, including the conduit 52.

The drying fluid thereafter enters and generally counterflow passes through a heat exchanger 55 which is part of the regeneration system 8 and from which the drying fluid discharges through an outlet 56 into the ambient air. The heat exchanger 55 can be of many conventional types including a shell and tube exchanger with a series of tubes represented by the schematic piping at the indicator 60. The exchanger 55 has a lower drain 61 for discharge of condensate 64 that collects on the tubes 60. It is foreseen that equivalent device for transferring heat such as a heat pump may be utilized instead of a conventional heat exchanger.

The heating fluid recirculation system 9 includes the tubing 33 in the chamber 6 along with a first closed conduit 70 that flow connects the tubing 33 with the tubing 60 of the heat exchanger 55 on the side opposite the drying fluid. The heat exchanger tubing 60 further flow connects with a second closed conduit 72 that joins with the front end of the chamber tubing 33. In this manner, the tubing 33, conduit 70, tubing 60 and conduit 72 form a closed path for circulating the heating fluid, as indicated by the arrows 74 and 75.

A pump 78 is located in the conduit 70 for operably propelling the heating fluid through the heating fluid recirculation system 9. Positioned in heat transfer communication with the conduit 72 and located between the exchanger 55 and the drying chamber 6 is a makeup heater 80. The heater 80 can be any type of device effective in transferring heat into the heating fluid contained in the conduit 72. The heater 80 includes a control 82 that operably causes the heater 80 to add sufficient makeup heat to the heating fluid so that the heating fluid exits the heater 80 at a preselected temperature which varies with the material to be dried.

In use, the material to be dried 12 is transferred to the chute 5 and loaded into the first end 17 of the drying chamber 6. The material 12 flows through the chamber 6 beneath the plates 42 under agitation due to continuous rotation of the chamber 6 and the slope of the chamber 6 between the front end 20 and discharge chute 24. The chamber 6 may include fins or the like to help in agitating the material 12, moving the material 12 along the chamber 6 and mixing the material 12 to provide for better convective transfer of vapor phase moisture to the drying fluid 44. As the material 12 is continually fed to the chamber 6, heating fluid at a preselected initial temperature is pumped into and through the heating tube 33 that is helically wound about the chamber 6. The heating fluid flows through the chamber 6 from near the front or first end 20 to a discharge near the rear or second end 38. As the heating fluid flows through the chamber 6, it heats the material 12 from front to rear and the heating fluid cools comparatively, exiting the chamber 6 at a substantially lower temperature. When ambient air is used as a drying fluid, the heating fluid exiting the chamber 6 is slightly above ambient temperature. Also, while the material 12 passes through the chamber 6, drying fluid, here air, enters the rear or second end 38 of the chamber 6 and flows in countercurrent flow relative to the material 12. The drying fluid is heated by the material 12 and heating fluid and acquires moisture from the material 12, so that the drying fluid exits near the front 38 of the chamber 6 both at an elevated temperature in comparison to the entry of the drying fluid into the chamber 6 and at least partially saturated with moisture from the material 12.

The heating fluid is recycled from the second end 38 of the drying chamber 6 to the heat exchanger 55 and the drying fluid is conveyed or flowed from the front 37 of the chamber 6 also to the exchanger 55, wherein the drying fluid operably pre heats the heating fluid. Subsequently, the heating fluid enters the make up heater 80 and is heated to a preselected temperature, for example, 180° F. which is chosen based upon characteristics of the material to be dried.

The length, diameter and shape of the chamber 6 are also chosen for the type of material 12 to be dried and how much moisture must be removed from the material 12. In some circumstances, the material 12 may be passed through the chamber 6 more than once so that the drier 1 removes a certain percentage of the moisture with each pass until a desired remaining moisture content is achieved. The interior of the chamber 6 may include various types of fins or the like to agitate the material 12.

A variation of this drier is foreseen under the invention wherein the plates in the drum are integral with and rotate with the drum and fill most of the cross section of the drum, but wherein an auger or other mass conveying device that rotates with the drum transfers material between adjacent sections.

It is also foreseen that a heat pump or similar device could be used to extract additional heat from the drying fluid that exits from the heat exchanger outlet 56 with the drying fluid and that the extracted heat could be then utilized to provide heat to the heating fluid prior to the heating fluid entering the makeup heater 110 or directly to the material 12 prior to entering the drier 1 or to other effective locations.

It is foreseen that a heat pump could also or alternatively e used to extract heat from an ambient air source and then utilized in the drier.

Shown in FIG. 1A is drier 100 that in many ways is quite similar to drier 1. Consequently, only major elements and the elements that are different are discussed in detail. Reference is made to the description of drier 1 for the remainder of the description of drier 100.

Drier 100 includes a drying chamber 106, a drying fluid circulation system 107, a regeneration system 108, a heating fluid recirculation system 109 and a makeup heater 110.

The principal difference in the drier 100 as compared to the drier 1 is that a conduit 115 is provided to collect drying fluid exiting the regeneration system 108 at an outlet 120. The conduit 115 recycles the drying fluid indicated by flow arrows 125 back to the rear side of the chamber 6 to a drying fluid inlet 126.

Located along the conduit 115 is a chiller 130 of conventional construction utilizing a heat exchanger and air cooling unit to cool the drying fluid to a preselected temperature, for example 70° F. A controller 131 operably maintains the temperature of the drying fluid as it exits the chiller 130, at the preselected temperature. The purpose of the chiller 130 is to return the drying fluid to or near the same starting temperature at the rear of the chamber 106 for each cycle thereof, so that the drying fluid does not increase somewhat in temperature with each cycle.

It is foreseen that the chiller could be located other places and perform an equivalent function or that a heat pump or the like could be used to cool the fluid. It is also foreseen that heat from such a heat pump could be utilized to provide a substantial portion of heat to the makeup heater 110. Condensate, due to moisture removal from the drying fluid, condenses in the chiller and is discharged through a drain 132 or the like so as to separate the condensate from the drying fluid.

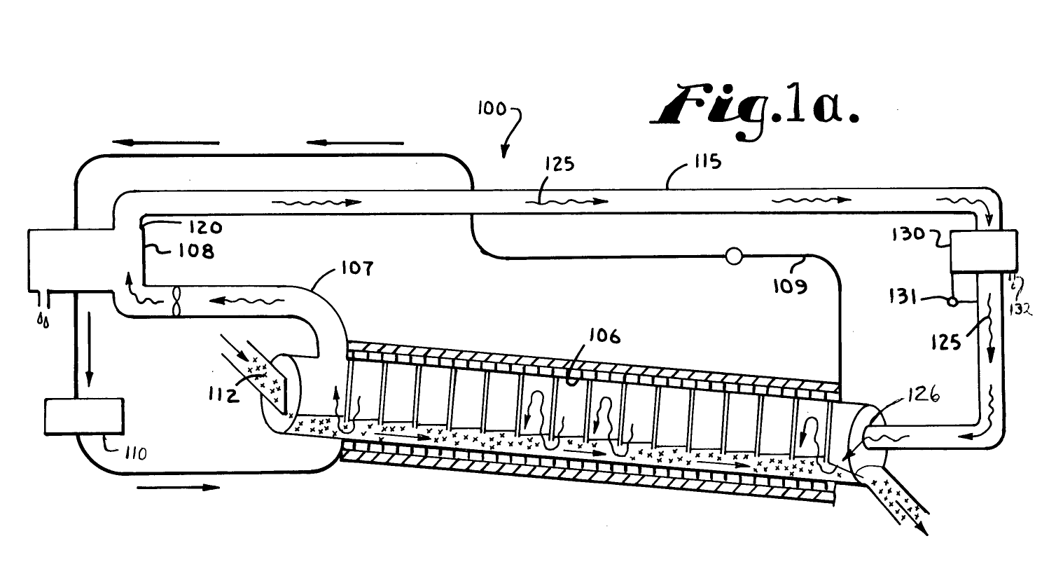

Shown in FIG. 2 is a drier 201. The drier 201 is similar to the previous described drier 1 and elements that are the same are not described again in detail, but rather reference is made to the description of drier 1.

The drier 201 includes a drying chamber 206, a drying fluid circulation system 207, a regenerator 208, a heating fluid recirculation system 209 and a makeup heater 280. The drier 201 differs from the drier 1 in that the drying chamber 206 is non segmented. Typically, the drier 201 will have a comparatively high ratio of length to diameter.

It is foreseen that the chamber 206 can include fins or the like to help in agitating the material being dried, both motivating the material along the chamber and mixing the material and drying fluid.

Shown in FIG. 2A is a drier 301 similar to drier 201 except as described below.

The drier 301 includes a drying chamber 306, a drying fluid circulation system 307, a regenerator 308, a heating fluid circulation system 309 and a makeup heater 380. The drier 301 differs from the drier 201 principally in that it includes a recirculation conduit 315 and a chiller 330 for circulating drying fluid from the regenerator 308 to the chamber 306 while cooling the drying fluid to a preselected temperature as in drier 100.

It is foreseen that in some embodiments the heating fluid and the drying fluid may flow overall generally counter current to each other, yet in stages or regions either or both may flow counter current, concurrent, cross or in mixed or in multiple types flow relative to the other. In this manner each flows stepwise in any of the described flows, but overall generally counter currently. The term stepwise, as used herein means sequential passage through different regions which may have fixed barriers or be open with respect to adjacent regions.

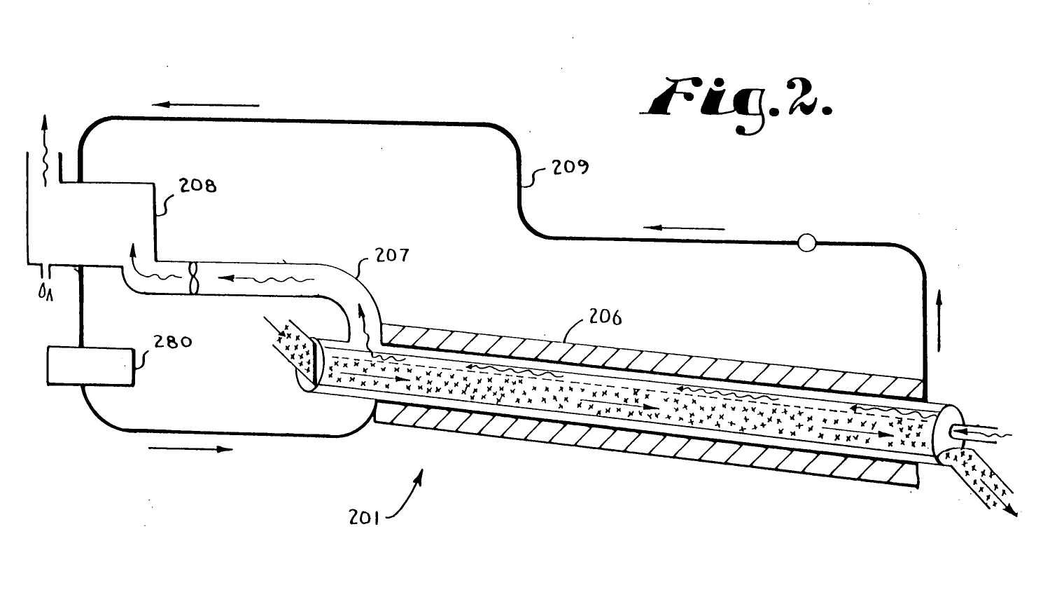

Shown in FIG. 3 is a flow process generally identified by the reference numeral 600 wherein a first component 601 which many be the heating fluid or the drying fluid in a vessel 603 that is either the drying chamber or the regenerator is flowed overall generally counter flow to a second component 602 which is the opposite fluid (ie, either the drying fluid or heating fluid). The second fluid 602 flows sequentially from left to right through a plurality or sequence of regions 604, 605 and 606. The first fluid 601 flows overall counter current to the second fluid 602, but in each region 604, 605, and 606 flows generally stepwise concurrently with respect to the second fluid 602.

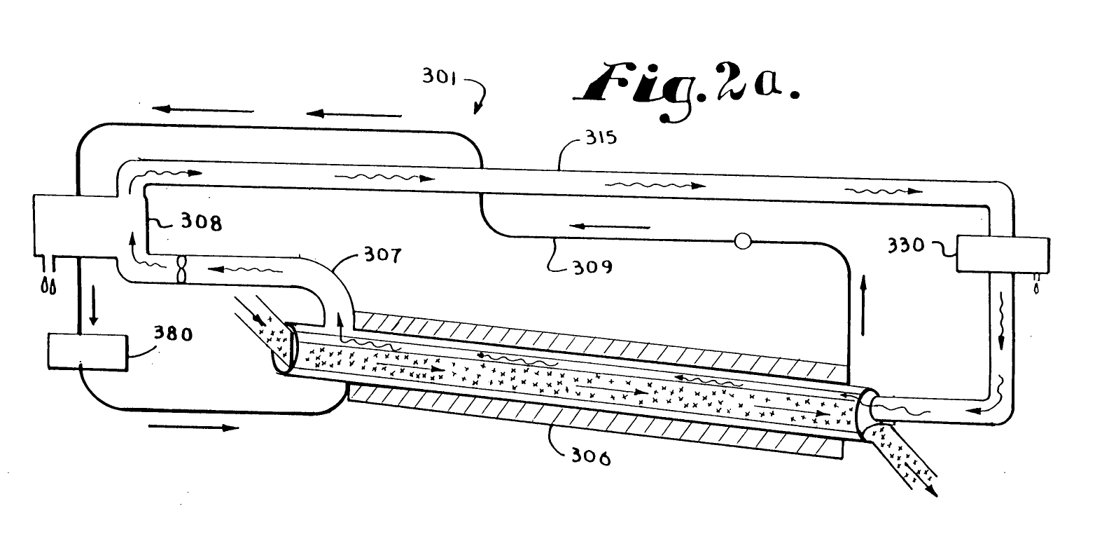

Shown in FIG. 4 is a flow process generally identified by the reference numeral 700 wherein a first component 701 which many be the heating fluid or the drying fluid in a vessel 703 that is either the drying chamber or the regenerator is flowed overall generally counter flow to a second component 702 which is the opposite fluid (ie, either the drying fluid or heating fluid). The second fluid 702 flows sequentially from left to right through a sequence of regions 704, 705 and 706. The first fluid 701 flows overall counter current to the second fluid 702, but in each region 704, 705, and 706 flows generally stepwise cross flow with respect to the second fluid 702.

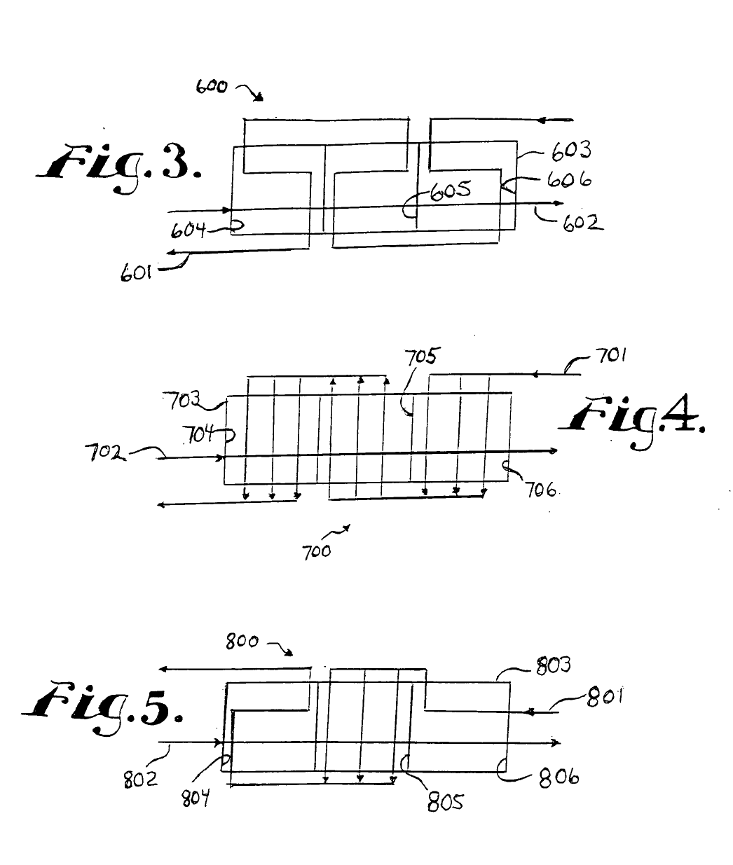

Shown in FIG. 5 is a flow process generally identified by the reference numeral 800 wherein a first component 801 which many be the heating fluid or the drying fluid in a vessel 803 that is either the drying chamber or the regenerator is flowed overall generally counter flow to a second component 802 which is the opposite fluid (ie, either the drying fluid or heating fluid). The second fluid 802 flows sequentially from left to right through a sequence of regions 804, 805 and 806. The first fluid 801 flows overall counter current to the second fluid 802, but in the region 806 flows generally counter current to the fluid 801, in the region 805 generally flows in cross flow relative to the second fluid 802 and in the region 804 flows generally concurrent relative to second fluid 802, so that the first component 801 generally stepwise flows in mixed flow with respect to the second component 802 through the vessel 805.

It is foreseen that the fluid driving mechanism, such as a fan could be located on either side the drying chamber and pull the fluid through the chamber in certain embodiments, such as in drier 1, or could push the fluid through.

It is foreseen that supplemental heat could be added to the drier to make up for losses in the method at many locations. In the embodiments shown, the heat is added subsequent to the heat exchange between the heating fluid and the drying fluid in the regenerator. However, the supplemental heat could be added to the material to be dried or to the heating fluid at other locations.

While a continuous counter flow process is described for the chamber and the regeneration systems in the embodiments described, it is foreseen that batch processes could be utilized using one or a series of sequential batch operations.

It is foreseen that the material to be dried may be conveyed through the chamber by other types of systems including, but not limited to augers, belts and the like.

While air and nitrogen are the most likely fluids to be used in a process of this type, it is foreseen that other fluids such as argon or the like may be used. Furthermore, while particular materials to be dried have been mentioned herein, it is foreseen that a wide variety of materials may be dried, including particulates and other granular materials, powders, flakes, pastes, slurries, and solids in general. Such materials are not restricted to but may be represented by foodstuffs, such as grains, beans, dog food, mixes, meals and flours; chemicals such as clays, coals, sand; and processed materials, such as paper and the like.

While drying of various materials through the vaporization of water and recovery of the heat of vaporization for return to the process is used to explain the invention herein, it is foreseen that the compound to be vaporized and removed from the material may be a volatile compound other than water. This process may be applied to removal of any compound that requires heat for volatilization of a compound from the surface or the interior of solid materials. The process is well adapted to situations where condensation and recovery of the volatile compound itself is of particular value.

It is foreseen that the drying chamber and/or regenerator can be operated under vacuum or pressurized in certain embodiments.

It is also foreseen that the chamber could be an enclosed structure or an open zone or region through which the material moves.

It is to be understood that while certain forms of the present invention have been illustrated and described herein, it is not to be limited to the specific forms or arrangement of parts described and shown.

What is claimed and desired to be secured by Letters Patent is as follows:

1. A drier apparatus for drying a material utilizing a first heating fluid and a second drying fluid comprising:
a) a drying chamber having first and second ends; said chamber being sized and shaped to operably receive said material near said first end and the drying fluid in a cool state near said second end;
b) a flow apparatus for flowing said heating fluid in heat transfer relationship relative to said material while said material is within said drying chamber and such that said heating fluid flows generally overall concurrently with said material, so that said material becomes heated by said heating fluid and releases moisture and said drying fluid flows generally overall counter flow to the material and drys said material while becoming more saturated with said moisture from the material as the drying fluid transverses from the second end to the first end of the chamber;
c) a heating fluid regenerator system operably receiving drying fluid in a heated state exiting from the first end of said chamber and heating fluid in a cooled state exiting from said chamber second end in heat exchange relationship so as to preheat said heating fluid;
d) a make up heater operably supplying makeup heat to said apparatus; and
e) heating fluid recirculation system circulating said heating fluid through said flow apparatus and said regenerator system.

2. The drier apparatus according to claim 1 including:
a) a fluid conduit flow joining a drying fluid discharge end of said regenerator system with the second end of said chamber, so as to provide for recycling of the drying fluid; and
b) a chiller located in said fluid conduit adapted to cool the drying fluid passing through said fluid conduit to a preselected temperature.

3. The drier apparatus according to claim 2 including:
a) conduit structure to convey heat from the chiller to the makeup heater.

4. The drier according to claim 1 wherein:
a) said makeup heater is located in said heating fluid recirculation system between said regenerator and said chamber.

5. The drier according to claim 1 wherein:
a) said chamber is a rotary drum.

6. The drier according to claim 5 wherein:
a) said chamber is segmented by suspended plates into a plurality of compartments.

7. The drier according to claim 1 wherein:
a) said chamber is selected from a group consisting vertical columns, inclined columns, tunnels, fluidized beds, belt, conveyor, web, rotary drum, disc and auger and tray type chambers.

8. A method of drying a material comprising the steps of:
a) passing the material through a drying chamber from a first end to a second end thereof;
b) flowing a heating fluid that is initially comparatively heated relative to said material in substantially concurrent segregated flow and in heat transfer relationship with said material while said material is in said chamber so as to heat said material;
c) flowing a drying fluid generally overall countercurrent through the material as the material passes through at least part of the chamber, such that the drying fluid receives heat and moisture from the material and the drying fluid exits the chamber hotter and wetter in comparison to entry of the drying fluid into the chamber and so that the material exits the chamber drier in comparison to entry of the material into the chamber;
d) withdrawing the heating fluid from the chamber and the drying fluid from the chamber and thereafter utilizing the drying fluid to preheat the heating fluid in a regenerator;
e) adding make up heat to the drier for heat lost in the method; and
f) returning the heating fluid in a heated state to the chamber to heat the material to be dried.

9. The method according to claim 8 including:
a) flowing said drying fluid in counter current flow through said chamber relative to said material.

10. The method according to claim 8 wherein:
a) said heating fluid is withdrawn from near said chamber second end and said drying fluid is withdrawn from near said chamber first end.

11. The method according to claim 8 including wherein:
a) the makeup heat is added to the heating fluid between the regenerator and the chamber.

12. The method according to claim 8 including the step of:
a) collecting the drying fluid subsequent to utilizing the drying fluid to preheat the heating fluid and returning the drying fluid to second end of the chamber.

13. The method according to claim 12 including the step of:
a) chilling the drying fluid to a preselected temperature prior to returning the drying fluid to the second end of the chamber.

14. The method according to claim 13 including the step of:
a) utilizing heat from the chiller as heat provided to the make up heater.

15. The method according to claim 8 including the step of:
a) counter flowing said drying fluid relative to the material in the chamber for the entire length of the chamber.

16. The method according to claim 8 including the step of:
a) step wise counterflowing said drying fluid through said material in said chamber.

17. The method according to claim 8 including the step of
a) flowing the drying fluid at least partially in counter flow through the material while the material is in the chamber.

18. The method according to claim 8 including the step of:
a) cross flowing the drying fluid through a plurality of individual segments of said chamber while overall generally counter flowing the drying fluid relative to said material while said material is within the chamber.

19. The method according to claim 8 including the step of:
a) mixed flowing the drying fluid through a plurality of individual segments of said chamber while overall generally counter flowing the drying fluid relative to said material while said material is within the chamber.

20. The method according to claim 8 including the step of:
a) concurrent flowing the drying fluid through a plurality of individual segments of said chamber while overall generally counter flowing the drying fluid relative to said material while said material is within the chamber.

21. The method according to claim 8 including the step of:
a) utilizing a heat pump to withdraw heat from the drying fluid exiting the regenerator and returning the withdrawn heat to the material.

22. The method according to claim 8 including the step of:
a) utilizing a heat pump to withdraw heat from ambient air and returning the withdrawn heat to the material.

23. The method according to claim 22 including wherein:
a) the withdrawn heat is returned to the material in the makeup heater.

24. In a drying process wherein a material is to be at least partially dried, the improvement comprising the steps of:
a) flowing the material from a first end of a drying chamber to a second end thereof;
b) flowing a heated fluid generally overall concurrently relative to said material while said material is in said chamber and in heat transfer relationship with said material in said chamber so as to transfer heat to said material while maintaining said heating fluid separate from said material;
c) flowing a drying fluid in direct contact with said material such that the drying fluid becomes heated and takes up moisture from said material, such that said material exits the second end of said chamber drier in comparison to the material at said first end of said chamber and such that said drying fluid becomes warmer and more saturated with moisture from the material during passage through said chamber; and
d) utilizing said drying fluid subsequent to passage through the chamber to preheat the heating fluid.

25. A method of drying a material comprising the steps of:
a) passing the material through a drying chamber from a first end to a second end thereof;
b) flowing a heating fluid in substantially concurrent segregated flow and in heat transfer contact with said material while said material is in said chamber so as to heat said material;
c) flowing a drying fluid through the material as the material passes through at least part of the chamber, such that the drying fluid receives heat and moisture from the material and the drying fluid exits the chamber hotter and wetter in comparison to entry of the drying fluid into the chamber and so that the material exits the chamber drier in comparison to entry of the material into the chamber;
d) withdrawing the heating fluid from the chamber and the drying fluid from the chamber and thereafter utilizing the drying fluid to preheat the heating fluid in a regenerator;
e) adding make up heat to the drier for heat lost in the method; and
f) returning the heating fluid in a heated state to the chamber to heat the material to be dried.

26. A method of drying a material comprising the steps of:
a) passing the material through a drying chamber from a first end to a second end thereof;
b) flowing a heating fluid in substantially concurrent segregated flow and in heat transfer relationship with said material while said material is in said chamber so as to heat said material;
c) flowing a drying fluid generally overall countercurrent through the material as the material passes through at least part of the chamber, such that the drying fluid receives heat and moisture from the material and the drying fluid exits the chamber hotter and wetter in comparison to entry of the drying fluid into the chamber and so that the material exits the chamber drier in comparison to entry of the material into the chamber;
d) withdrawing the heating fluid from the chamber and the drying fluid from the chamber and thereafter utilizing the drying fluid to preheat the heating fluid in a regenerator;
e) adding make up heat to the drier for heat lost in the method; and
f) returning the heating fluid in a heated state to the chamber to heat the material to be dried.
